(19) United States
(12) Patent Application Publication
(10) Pub. No.: US 2026/0329660 A1
(43) Pub. Date: Oct. 22, 2026

(54) AUTONOMOUS ENFORCEMENT OF SERVICE LEVEL OBJECTIVES

(71) Applicant: Express Scripts Strategic Development, Inc., St. Louis, MO (US)

(72) Inventors: Kumararajan Rajan, South Windsor, CT (US); Kartheek Chakkilala, Cary, NC (US)

(21) Appl. No.: 19/653,957

(22) Filed: Apr. 21, 2026

Related U.S. Application Data
(60) Provisional application No. 63/791,951, filed on Apr. 21, 2025.

(51) Int. Cl. G06F 9/50; G06F 11/34; G06F 11/3604

(52) U.S. Cl. CPC G06F 9/5055; G06F 11/3409; G06F 11/3612

(57) ABSTRACT

A method includes receiving a data structure describing a set of services and a set of criteria. The data structure includes a set of key-value pairs. A first key-value pair contains a key corresponding to a specified service. The first key-value pair contains a value including a criterion and a query corresponding to the set of criteria and to the specified service. The method includes storing the set of services and the set of criteria, monitoring the set of services, and based on the monitoring, determining whether the set of services meets the set of criteria. The method includes, in response to a determination that the set of services does not meet the set of criteria: determining a set of improvements for the set of services and generating a notification.

### CROSS-REFERENCE TO RELATED APPLICATIONS

This application claims the benefit of U.S. Provisional Application No. 63/791,951 (Attorney Docket No. ESRX-483PRV) filed Apr. 21, 2025. The entire disclosure of the above application is incorporated by reference.

### FIELD

The present disclosure relates to program execution monitoring, and more particularly to autonomous monitoring of performance parameters of networked resources.

### BACKGROUND

Service level objectives (“SLOs”) are a measurable target that defines how well a service (such as a website or software) should perform. SLOs can include website availability (such as 99% of the time), response time (such as less than 500 ms), and/or error rate (such as below 1%). However, a solution is required to monitor and enforce SLOs.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A method includes receiving a data structure describing a set of services and a set of criteria for the set of services. The data structure includes a set of key-value pairs. A first key-value pair of the set of key-value pairs contains a key corresponding to a specified service of the set of services. The first key-value pair contains a value including a criterion of the set of criteria, and a query corresponding to the set of criteria and to the specified service. The method includes storing the set of services and the set of criteria. The method includes monitoring the set of services. The method includes, based on the monitoring, determining whether the set of services meets the set of criteria. The method includes, in response to a determination that the set of services does not meet the set of criteria, determining, using a machine learning model, a set of improvements for the set of services and generating a notification including the set of improvements. The method includes, in response to a determination that the set of services meets the set of criteria, forgoing determining the set of improvements and forgoing generating the notification.

In other features, the query of the first key-value pair corresponds to a command for testing the specified service.

In other features, the method includes generating the data structure based on a code repository.

In other features, the set of criteria includes at least one of a criterion that is met when a request latency is below a latency threshold, a criterion that is met when a yield level is above a yield threshold, a criterion that is met when an error rate is below an error threshold, a criterion that is met when a service throughput level is above a throughput threshold, a criterion that is met when an availability level is above an availability threshold, a criterion that is met when a data durability level is above a durability threshold, or a criterion that is met when a data retention level is above a retention threshold.

In other features, determining the set of improvements includes analyzing, via a machine learning model, source code associated with the set of services.

In other features, the method includes directing an artificial intelligence agent with a prompt. The prompt includes instructions for cloning a software repository. The prompt includes instructions for determining whether a specified vulnerability exists in the software repository. The prompt includes instructions for, in response to a determination that the specified vulnerability exists in the software repository, determining a remediation for the specified vulnerability, and creating a request to apply the remediation to the software repository.

In other features, the remediation includes updating a runtime platform used by the software repository. In other features, the prompt includes instructions for outputting a structured data file describing outcomes of the remediation. In other features, the prompt includes instructions for determining a quantity of remediated vulnerabilities. In other features, the prompt includes instructions to ignore vulnerabilities that are not specified by the prompt.

In other features, the prompt includes instructions for, in response to a determination that cloning the software repository has failed, outputting a structured data file. The structured data file includes a failure status flag and information indicating an error associated with the failure status flag.

A system includes memory hardware configured to store instructions and processor hardware configured to execute the instructions stored by the memory hardware. The instructions include receiving a data structure describing a set of services and a set of criteria for the set of services. The data structure includes a set of key-value pairs. A first key-value pair of the set of key-value pairs contains a key corresponding to a specified service of the set of services. The first key-value pair contains a value including a criterion of the set of criteria, and a query corresponding to the set of criteria and to the specified service. The instructions include storing the set of services and the set of criteria. The instructions include monitoring the set of services. The instructions include, based on the monitoring, determining whether the set of services meets the set of criteria. The instructions include, in response to a determination that the set of services does not meet the set of criteria, determining, using a machine learning model, a set of improvements for the set of services, and generating a notification including the set of improvements. The instructions include, in response to a determination that the set of services meets the set of criteria, forgoing determining the set of improvements and forgoing generating the notification.

In other features, the query of the first key-value pair corresponds to a command for testing the specified service.

In other features, the instructions include generating the data structure based on a code repository.

In other features, the set of criteria includes at least one of a criterion that is met when a request latency is below a latency threshold, a criterion that is met when a yield level is above a yield threshold, a criterion that is met when an error rate is below an error threshold, a criterion that is met when a service throughput level is above a throughput threshold, a criterion that is met when an availability level is above an availability threshold, a criterion that is met when a data durability level is above a durability threshold, or a criterion that is met when a data retention level is above a retention threshold.

A non-transitory computer-readable medium includes processor-executable instructions. The instructions include receiving a data structure describing a set of services and a set of criteria for the set of services. The data structure includes a set of key-value pairs. A first key-value pair of the set of key-value pairs contains a key corresponding to a specified service of the set of services. The first key-value pair contains a value including a criterion of the set of criteria, and a query corresponding to the set of criteria and to the specified service. The instructions include storing the set of services and the set of criteria. The instructions include monitoring the set of services. The instructions include, based on the monitoring, determining whether the set of services meets the set of criteria. The instructions include, in response to a determination that the set of services does not meet the set of criteria, determining, using a machine learning model, a set of improvements for the set of services, and generating a notification including the set of improvements. The instructions include, in response to a determination that the set of services meets the set of criteria, forgoing determining the set of improvements and forgoing generating the notification.

In other features, the query of the first key-value pair corresponds to a command for testing the specified service. In other features, the instructions include generating the data structure based on a code repository.

In other features, the set of criteria includes at least one of a criterion that is met when a request latency is below a latency threshold, a criterion that is met when a yield level is above a yield threshold, a criterion that is met when an error rate is below an error threshold, a criterion that is met when a service throughput level is above a throughput threshold, a criterion that is met when an availability level is above an availability threshold, a criterion that is met when a data durability level is above a durability threshold, or a criterion that is met when a data retention level is above a retention threshold.

In other features, determining the set of improvements includes analyzing, via a machine learning model, source code associated with the set of services.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example system including a high-volume pharmacy.

FIG. 2 is a functional block diagram of an example pharmacy fulfillment device, which may be deployed within the system of FIG. 1.

FIG. 3 is a functional block diagram of an example order processing device, which may be deployed within the system of FIG. 1.

FIG. 4 is a functional block diagram of an example system for enforcing service level objectives.

FIG. 5 is a flowchart of an example method for enforcing service level objectives.

FIG. 6 is a functional block diagram of an example system for enforcing service level objectives.

FIG. 7 is a set of example schema for various service level objectives.

FIG. 8 is an example user interface for monitoring service level objectives.

FIG. 9 is an example user interface for managing service level objectives.

FIG. 10 is a flowchart of an example method for deploying service level objective monitoring.

In the drawings, reference numbers may be reused to identify similar and/or identical elements.

### DETAILED DESCRIPTION

### Introduction

The present disclosure is directed to a system for monitoring and enforcing service level objectives (“SLOs”). Various resources and/or services (such as microservices) are onboarded into a monitoring platform that monitors features that correspond to SLOs. In various embodiments, the monitoring platform identifies the features that correspond to SLOs. The features are monitored (for example, when execution of a service begins and ends) and analyzed to confirm whether the feature meets the satisfaction criteria. In various embodiments, if a feature does not meet satisfaction criteria, an alert is generated. In various embodiments, if a feature does not meet satisfaction criteria, the code of the feature is analyzed via a machine learning model (such as a large language model) to determine a change to the code to improve performance or meet the satisfaction criteria.

In various embodiments, SLOs are represented in a structured data format (such as JSON or YAML). In various embodiments, the structured data defines the SLOs and the associated expected performance. In various embodiments, an SLO and expected performance is structured as a key-value pair. In various embodiments, the structured data format defines an expected request latency, yield rate, error rate, service throughput, availability, durability, and/or data retention. In various embodiments, the structured data format includes queries that define (such as via a command, macro, and/or script) how to test each SLO. For example, the query may include a specific URL or API that is being measured and specify how to measure the SLO. In various embodiments, the structured data format is generated based on an SLO agreement and a code repository corresponding to the SLO.

### High-Volume Pharmacy

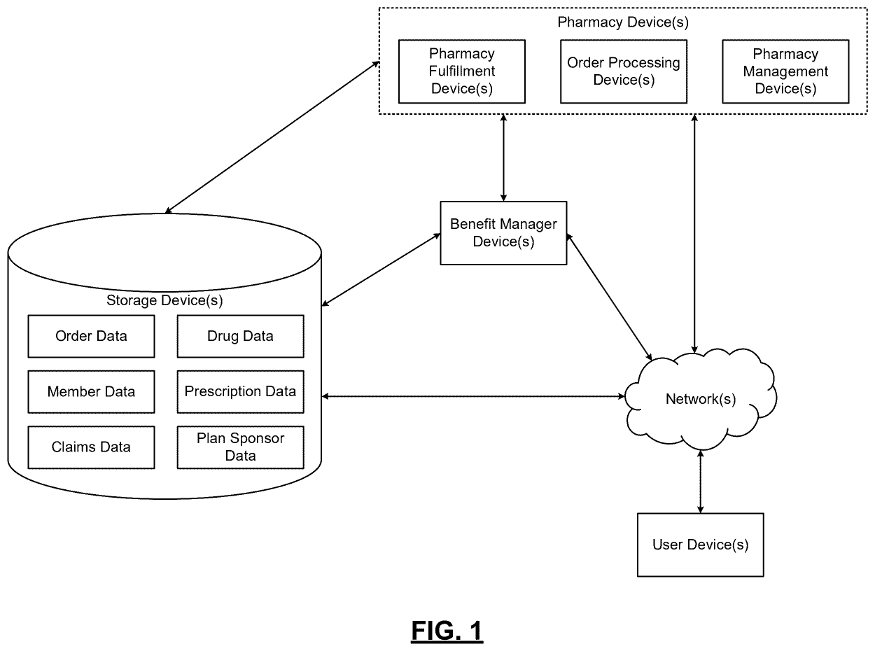

FIG. 1 is a block diagram of an example implementation of a system 100 for a high-volume pharmacy. While the system 100 is generally described as being deployed in a high-volume pharmacy or a fulfillment center (for example, a mail order pharmacy, a direct delivery pharmacy, etc.), the system 100 and/or components of the system 100 may otherwise be deployed (for example, in a lower-volume pharmacy, etc.). A high-volume pharmacy may be a pharmacy that is capable of filling at least some prescriptions mechanically. The system 100 may include a benefit manager device 102 and a pharmacy device 106 in communication with each other directly and/or over a network 104.

The system 100 may also include one or more user device(s) 108. A user, such as a pharmacist, patient, data analyst, health plan administrator, etc., may access the benefit manager device 102 or the pharmacy device 106 using the user device 108. The user device 108 may be a desktop computer, a laptop computer, a tablet, a smartphone, etc.

The benefit manager device 102 is a device operated by an entity that is at least partially responsible for the creation and/or management of the pharmacy or drug benefit. While the entity operating the benefit manager device 102 is typically a pharmacy benefit manager (PBM), other entities may operate the benefit manager device 102 on behalf of themselves or other entities (such as PBMs). For example, the benefit manager device 102 may be operated by a health plan, a retail pharmacy chain, a drug wholesaler, a data analytics or other type of software-related company, etc. In some implementations, a PBM that provides the pharmacy benefit may provide one or more additional benefits including a medical or health benefit, a dental benefit, a vision benefit, a wellness benefit, a radiology benefit, a pet care benefit, an insurance benefit, a long-term care benefit, a nursing home benefit, etc. The PBM may, in addition to its PBM operations, operate one or more pharmacies. The pharmacies may be retail pharmacies, mail order pharmacies, etc.

Some of the operations of the PBM that operates the benefit manager device 102 may include the following activities and processes. A member (or a person on behalf of the member) of a pharmacy benefit plan may obtain a prescription drug at a retail pharmacy location (e.g., a location of a physical store) from a pharmacist or a pharmacist technician. The member may also obtain the prescription drug through mail order drug delivery from a mail order pharmacy location, such as the system 100. In some implementations, the member may obtain the prescription drug directly or indirectly through the use of a machine, such as a kiosk, a vending unit, a mobile electronic device, or a different type of mechanical device, electrical device, electronic communication device, and/or computing device. Such a machine may be filled with the prescription drug in prescription packaging, which may include multiple prescription components, by the system 100. The pharmacy benefit plan is administered by or through the benefit manager device 102.

The member may have a copayment for the prescription drug that reflects an amount of money that the member is responsible to pay the pharmacy for the prescription drug. The money paid by the member to the pharmacy may come from, as examples, the personal funds of the member, a health savings account (HSA) of the member or the member's family, a health reimbursement arrangement (HRA) of the member or the member's family, or a flexible spending account (FSA) of the member or the member's family. In some instances, an employer of the member may directly or indirectly fund or reimburse the member for the copayments.

The amount of the copayment required by the member may vary across different pharmacy benefit plans having different plan sponsors or clients and/or for different prescription drugs. The member's copayment may be a flat copayment (in one example, $10), coinsurance (in one example, 10%), and/or a deductible (for example, responsibility for the first $500 of annual prescription drug expense, etc.) for certain prescription drugs, certain types and/or classes of prescription drugs, and/or all prescription drugs. The copayment may be stored in a storage device 110 or determined by the benefit manager device 102.

In some instances, the member may not pay the copayment or may only pay a portion of the copayment for the prescription drug. For example, if a usual and customary cost for a generic version of a prescription drug is $4, and the member's flat copayment is $20 for the prescription drug, the member may only need to pay $4 to receive the prescription drug. In another example involving a worker's compensation claim, no copayment may be due by the member for the prescription drug.

In addition, copayments may also vary based on different delivery channels for the prescription drug. For example, the copayment for receiving the prescription drug from a mail-order pharmacy location may be less than the copayment for receiving the prescription drug from a retail pharmacy location.

In conjunction with receiving a copayment (if any) from the member and dispensing the prescription drug to the member, the pharmacy submits a claim to the PBM for the prescription drug. After receiving the claim, the PBM (such as by using the benefit manager device 102) may perform certain adjudication operations including verifying eligibility for the member, identifying/reviewing an applicable formulary for the member to determine any appropriate copayment, coinsurance, and deductible for the prescription drug, and performing a drug utilization review (DUR) for the member. Further, the PBM may provide a response to the pharmacy (for example, the pharmacy system 100) following performance of at least some of the aforementioned operations.

As part of the adjudication, a plan sponsor (or the PBM on behalf of the plan sponsor) ultimately reimburses the pharmacy for filling the prescription drug when the prescription drug was successfully adjudicated. The aforementioned adjudication operations generally occur before the copayment is received and the prescription drug is dispensed. However in some instances, these operations may occur simultaneously, substantially simultaneously, or in a different order. In addition, more or fewer adjudication operations may be performed as at least part of the adjudication process.

The amount of reimbursement paid to the pharmacy by a plan sponsor and/or money paid by the member may be determined at least partially based on types of pharmacy networks in which the pharmacy is included. In some implementations, the amount may also be determined based on other factors. For example, if the member pays the pharmacy for the prescription drug without using the prescription or drug benefit provided by the PBM, the amount of money paid by the member may be higher than when the member uses the prescription or drug benefit. In some implementations, the amount of money received by the pharmacy for dispensing the prescription drug and for the prescription drug itself may be higher than when the member uses the prescription or drug benefit. Some or all of the foregoing operations may be performed by executing instructions stored in the benefit manager device 102 and/or an additional device.

Examples of the network 104 include a Global System for Mobile Communications (GSM) network, a code division multiple access (CDMA) network, 3rd Generation Partnership Project (3GPP), an Internet Protocol (IP) network, a Wireless Application Protocol (WAP) network, or an IEEE 802.11 standards network, as well as various combinations of the above networks. The network 104 may include an optical network. The network 104 may be a local area network or a global communication network, such as the Internet. In some implementations, the network 104 may include a network dedicated to prescription orders: a prescribing network such as the electronic prescribing network operated by Surescripts of Arlington, Virginia.

Moreover, although the system shows a single network 104, multiple networks can be used. The multiple networks may communicate in series and/or parallel with each other to link the devices 102-110.

The pharmacy device 106 may be a device associated with a retail pharmacy location (e.g., an exclusive pharmacy location, a grocery store with a retail pharmacy, or a general sales store with a retail pharmacy) or other type of pharmacy location at which a member attempts to obtain a prescription. The pharmacy may use the pharmacy device 106 to submit the claim to the PBM for adjudication.

Additionally, in some implementations, the pharmacy device 106 may enable information exchange between the pharmacy and the PBM. For example, this may allow the sharing of member information such as drug history that may allow the pharmacy to better service a member (for example, by providing more informed therapy consultation and drug interaction information). In some implementations, the benefit manager device 102 may track prescription drug fulfillment and/or other information for users that are not members, or have not identified themselves as members, at the time (or in conjunction with the time) in which they seek to have a prescription filled at a pharmacy.

The pharmacy device 106 may include a pharmacy fulfillment device 112, an order processing device 114, and a pharmacy management device 116 in communication with each other directly and/or over the network 104. The order processing device 114 may receive information regarding filling prescriptions and may direct an order component to one or more devices of the pharmacy fulfillment device 112 at a pharmacy. The pharmacy fulfillment device 112 may fulfill, dispense, aggregate, and/or pack the order components of the prescription drugs in accordance with one or more prescription orders directed by the order processing device 114.

In general, the order processing device 114 is a device located within or otherwise associated with the pharmacy to enable the pharmacy fulfillment device 112 to fulfill a prescription and dispense prescription drugs. In some implementations, the order processing device 114 may be an external order processing device separate from the pharmacy and in communication with other devices located within the pharmacy.

For example, the external order processing device may communicate with an internal pharmacy order processing device and/or other devices located within the system 100. In some implementations, the external order processing device may have limited functionality (e.g., as operated by a user requesting fulfillment of a prescription drug), while the internal pharmacy order processing device may have greater functionality (e.g., as operated by a pharmacist).

The order processing device 114 may track the prescription order as it is fulfilled by the pharmacy fulfillment device 112. The prescription order may include one or more prescription drugs to be filled by the pharmacy. The order processing device 114 may make pharmacy routing decisions and/or order consolidation decisions for the particular prescription order. The pharmacy routing decisions include what device(s) in the pharmacy are responsible for filling or otherwise handling certain portions of the prescription order. The order consolidation decisions include whether portions of one prescription order or multiple prescription orders should be shipped together for a user or a user family. The order processing device 114 may also track and/or schedule literature or paperwork associated with each prescription order or multiple prescription orders that are being shipped together. In some implementations, the order processing device 114 may operate in combination with the pharmacy management device 116.

The order processing device 114 may include circuitry, a processor, a memory to store data and instructions, and communication functionality. The order processing device 114 is dedicated to performing processes, methods, and/or instructions described in this application. Other types of electronic devices may also be used that are specifically configured to implement the processes, methods, and/or instructions described in further detail below.

In some implementations, at least some functionality of the order processing device 114 may be included in the pharmacy management device 116. The order processing device 114 may be in a client-server relationship with the pharmacy management device 116, in a peer-to-peer relationship with the pharmacy management device 116, or in a different type of relationship with the pharmacy management device 116. The order processing device 114 and/or the pharmacy management device 116 may communicate directly (for example, such as by using a local storage) and/or through the network 104 (such as by using a cloud storage configuration, software as a service, etc.) with the storage device 110.

The storage device 110 may include: non-transitory storage (for example, memory, hard disk, CD-ROM, etc.) in communication with the benefit manager device 102 and/or the pharmacy device 106 directly and/or over the network 104. The non-transitory storage may store order data 118, member data 120, claims data 122, drug data 124, prescription data 126, and/or plan sponsor data 128. Further, the system 100 may include additional devices, which may communicate with each other directly or over the network 104.

The order data 118 may be related to a prescription order. The order data may include the type of the prescription drug (for example, drug name and strength) and the quantity of the prescription drug. The order data 118 may also include data used for completion of the prescription, such as prescription materials. In general, prescription materials include an electronic copy of information regarding the prescription drug for inclusion with or otherwise in conjunction with the fulfilled prescription. The prescription materials may include electronic information regarding drug interaction warnings, recommended usage, possible side effects, expiration date, date of prescribing, etc. The order data 118 may be used by a high-volume fulfillment center to fulfill a pharmacy order.

In some implementations, the order data 118 includes verification information associated with fulfillment of the prescription in the pharmacy. For example, the order data 118 may include videos and/or images taken of (i) the prescription drug prior to dispensing, during dispensing, and/or after dispensing, (ii) the prescription container (for example, a prescription container and sealing lid, prescription packaging, etc.) used to contain the prescription drug prior to dispensing, during dispensing, and/or after dispensing, (iii) the packaging and/or packaging materials used to ship or otherwise deliver the prescription drug prior to dispensing, during dispensing, and/or after dispensing, and/or (iv) the fulfillment process within the pharmacy. Other types of verification information such as barcode data read from pallets, bins, trays, or carts used to transport prescriptions within the pharmacy may also be stored as order data 118.

The member data 120 includes information regarding the members associated with the PBM. The information stored as member data 120 may include personal information, personal health information, protected health information, etc. Examples of the member data 120 include name, age, date of birth, address (including city, state, and zip code), telephone number, e-mail address, medical history, prescription drug history, etc. In various implementations, the prescription drug history may include a prior authorization claim history—including the total number of prior authorization claims, approved prior authorization claims, and denied prior authorization claims. In various implementations, the prescription drug history may include previously filled claims for the member, including a date of each filled claim, a dosage of each filled claim, the drug type for each filled claim, a prescriber associated with each filled claim, and whether the drug associated with each claim is on a formulary (e.g., a list of covered medication).

In various implementations, the medical history may include whether and/or how well each member adhered to one or more specific therapies. The member data 120 may also include a plan sponsor identifier that identifies the plan sponsor associated with the member and/or a member identifier that identifies the member to the plan sponsor. The member data 120 may include a member identifier that identifies the plan sponsor associated with the user and/or a user identifier that identifies the user to the plan sponsor. In various implementations, the member data 120 may include an eligibility period for each member. For example, the eligibility period may include how long each member is eligible for coverage under the sponsored plan. The member data 120 may also include dispensation preferences such as type of label, type of cap, message preferences, language preferences, etc.

The member data 120 may be accessed by various devices in the pharmacy (for example, the high-volume fulfillment center, etc.) to obtain information used for fulfillment and shipping of prescription orders. In some implementations, an external order processing device operated by or on behalf of a member may have access to at least a portion of the member data 120 for review, verification, or other purposes.

In some implementations, the member data 120 may include information for persons who are users of the pharmacy but are not members in the pharmacy benefit plan being provided by the PBM. For example, these users may obtain drugs directly from the pharmacy, through a private label service offered by the pharmacy, the high-volume fulfillment center, or otherwise. In general, the terms “member” and “user” may be used interchangeably.

The claims data 122 includes information regarding pharmacy claims adjudicated by the PBM under a drug benefit program provided by the PBM for one or more plan sponsors. In general, the claims data 122 includes an identification of the client that sponsors the drug benefit program under which the claim is made, and/or the member that purchased the prescription drug giving rise to the claim, the prescription drug that was filled by the pharmacy (e.g., the national drug code number, etc.), the dispensing date, generic indicator, generic product identifier (GPI) number, medication class, the cost of the prescription drug provided under the drug benefit program, the copayment/coinsurance amount, rebate information, and/or member eligibility, etc. Additional information may be included.

In some implementations, other types of claims beyond prescription drug claims may be stored in the claims data 122. For example, medical claims, dental claims, wellness claims, or other types of health-care-related claims for members may be stored as a portion of the claims data 122.

In some implementations, the claims data 122 includes claims that identify the members with whom the claims are associated. Additionally or alternatively, the claims data 122 may include claims that have been de-identified (that is, associated with a unique identifier but not with a particular, identifiable member). In various implementations, the claims data 122 may include a percentage of prior authorization cases for each prescriber that have been denied, and a percentage of prior authorization cases for each prescriber that have been approved.

The drug data 124 may include drug name (e.g., technical name and/or common name), other names by which the drug is known, active ingredients, an image of the drug (such as in pill form), etc. The drug data 124 may include information associated with a single medication or multiple medications. For example, the drug data 124 may include a numerical identifier for each drug, such as the U.S. Food and Drug Administration's (FDA) National Drug Code (NDC) for each drug.

The prescription data 126 may include information regarding prescriptions that may be issued by prescribers on behalf of users, who may be members of the pharmacy benefit plan—for example, to be filled by a pharmacy. Examples of the prescription data 126 include user names, medication or treatment (such as lab tests), dosing information, etc. The prescriptions may include electronic prescriptions or paper prescriptions that have been scanned. In some implementations, the dosing information reflects a frequency of use (e.g., once a day, twice a day, before each meal, etc.) and a duration of use (e.g., a few days, a week, a few weeks, a month, etc.).

In some implementations, the order data 118 may be linked to associated member data 120, claims data 122, drug data 124, and/or prescription data 126.

The plan sponsor data 128 includes information regarding the plan sponsors of the PBM. Examples of the plan sponsor data 128 include company name, company address, contact name, contact telephone number, contact e-mail address, etc.

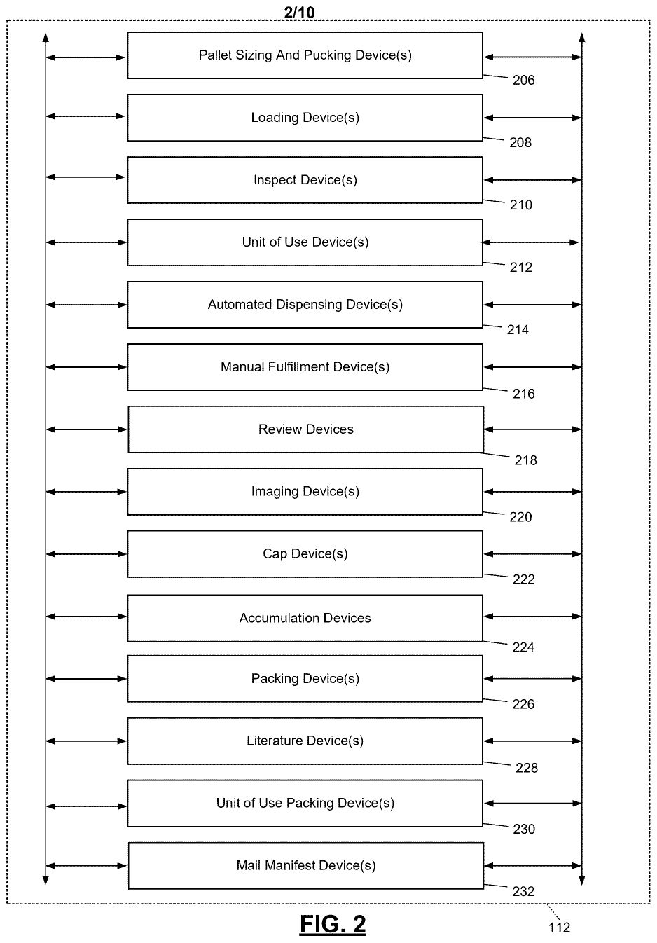

FIG. 2 illustrates the pharmacy fulfillment device 112 according to an example implementation. The pharmacy fulfillment device 112 may be used to process and fulfill prescriptions and prescription orders. After fulfillment, the fulfilled prescriptions are packed for shipping.

The pharmacy fulfillment device 112 may include devices in communication with the benefit manager device 102, the order processing device 114, and/or the storage device 110, directly or over the network 104. Specifically, the pharmacy fulfillment device 112 may include pallet sizing and pucking device(s) 206, loading device(s) 208, inspect device(s) 210, unit of use device(s) 212, automated dispensing device(s) 214, manual fulfillment device(s) 216, review devices 218, imaging device(s) 220, cap device(s) 222, accumulation devices 224, packing device(s) 226, literature device(s) 228, unit of use packing device(s) 230, and mail manifest device(s) 232. Further, the pharmacy fulfillment device 112 may include additional devices, which may communicate with each other directly or over the network 104.

In some implementations, operations performed by one of these devices 206-232 may be performed sequentially, or in parallel with the operations of another device as may be coordinated by the order processing device 114. In some implementations, the order processing device 114 tracks a prescription with the pharmacy based on operations performed by one or more of the devices 206-232.

In some implementations, the pharmacy fulfillment device 112 may transport prescription drug containers, for example, among the devices 206-232 in the high-volume fulfillment center, by use of pallets. The pallet sizing and pucking device 206 may configure pucks in a pallet. A pallet may be a transport structure for a number of prescription containers, and may include a number of cavities. A puck may be placed in one or more than one of the cavities in a pallet by the pallet sizing and pucking device 206. The puck may include a receptacle sized and shaped to receive a prescription container. Such containers may be supported by the pucks during carriage in the pallet. Different pucks may have differently sized and shaped receptacles to accommodate containers of differing sizes, as may be appropriate for different prescriptions.

The arrangement of pucks in a pallet may be determined by the order processing device 114 based on prescriptions that the order processing device 114 decides to launch. The arrangement logic may be implemented directly in the pallet sizing and pucking device 206. Once a prescription is set to be launched, a puck suitable for the appropriate size of container for that prescription may be positioned in a pallet by a robotic arm or pickers. The pallet sizing and pucking device 206 may launch a pallet once pucks have been configured in the pallet.

The loading device 208 may load prescription containers into the pucks on a pallet by a robotic arm, a pick and place mechanism (also referred to as pickers), etc. In various implementations, the loading device 208 has robotic arms or pickers to grasp a prescription container and move it to and from a pallet or a puck. The loading device 208 may also print a label that is appropriate for a container that is to be loaded onto the pallet, and apply the label to the container. The pallet may be located on a conveyor assembly during these operations (e.g., at the high-volume fulfillment center, etc.).

The inspect device 210 may verify that containers in a pallet are correctly labeled and in the correct spot on the pallet. The inspect device 210 may scan the label on one or more containers on the pallet. Labels of containers may be scanned or imaged in full or in part by the inspect device 210. Such imaging may occur after the container has been lifted out of its puck by a robotic arm, picker, etc., or may be otherwise scanned or imaged while retained in the puck. In some implementations, images and/or video captured by the inspect device 210 may be stored in the storage device 110 as order data 118.

The unit of use device 212 may temporarily store, monitor, label, and/or dispense unit of use products. In general, unit of use products are prescription drug products that may be delivered to a user or member without being repackaged at the pharmacy. These products may include pills in a container, pills in a blister pack, inhalers, etc. Prescription drug products dispensed by the unit of use device 212 may be packaged individually or collectively for shipping, or may be shipped in combination with other prescription drugs dispensed by other devices in the high-volume fulfillment center.

At least some of the operations of the devices 206-232 may be directed by the order processing device 114. For example, the manual fulfillment device 216, the review device 218, the automated dispensing device 214, and/or the packing device 226, etc. may receive instructions provided by the order processing device 114.

The automated dispensing device 214 may include one or more devices that dispense prescription drugs or pharmaceuticals into prescription containers in accordance with one or multiple prescription orders. In general, the automated dispensing device 214 may include mechanical and electronic components with, in some implementations, software and/or logic to facilitate pharmaceutical dispensing that would otherwise be performed in a manual fashion by a pharmacist and/or pharmacist technician. For example, the automated dispensing device 214 may include high-volume fillers that fill a number of prescription drug types at a rapid rate and blister pack machines that dispense and pack drugs into a blister pack. Prescription drugs dispensed by the automated dispensing devices 214 may be packaged individually or collectively for shipping, or may be shipped in combination with other prescription drugs dispensed by other devices in the high-volume fulfillment center.

The manual fulfillment device 216 controls how prescriptions are manually fulfilled. For example, the manual fulfillment device 216 may receive or obtain a container and enable fulfillment of the container by a pharmacist or pharmacy technician. In some implementations, the manual fulfillment device 216 provides the filled container to another device in the pharmacy fulfillment devices 112 to be joined with other containers in a prescription order for a user or member.

In general, manual fulfillment may include operations at least partially performed by a pharmacist or a pharmacy technician. For example, a person may retrieve a supply of the prescribed drug, may make an observation, may count out a prescribed quantity of drugs and place them into a prescription container, etc. Some portions of the manual fulfillment process may be automated by use of a machine. For example, counting of capsules, tablets, or pills may be at least partially automated (such as through use of a pill counter). Prescription drugs dispensed by the manual fulfillment device 216 may be packaged individually or collectively for shipping, or may be shipped in combination with other prescription drugs dispensed by other devices in the high-volume fulfillment center.

The review device 218 may process prescription containers to be reviewed by a pharmacist for proper pill count, exception handling, prescription verification, etc. Fulfilled prescriptions may be manually reviewed and/or verified by a pharmacist, as may be required by state or local law. A pharmacist or other licensed pharmacy person who may dispense certain drugs in compliance with local and/or other laws may operate the review device 218 and visually inspect a prescription container that has been filled with a prescription drug. The pharmacist may review, verify, and/or evaluate drug quantity, drug strength, and/or drug interaction concerns, or otherwise perform pharmacist services. The pharmacist may also handle containers which have been flagged as an exception, such as containers with unreadable labels, containers for which the associated prescription order has been canceled, containers with defects, etc. In an example, the manual review can be performed at a manual review station.

The imaging device 220 may image containers once they have been filled with pharmaceuticals. The imaging device 220 may measure a fill height of the pharmaceuticals in the container based on the obtained image to determine if the container is filled to the correct height given the type of pharmaceutical and the number of pills in the prescription. Images of the pills in the container may also be obtained to detect the size of the pills themselves and markings thereon. The images may be transmitted to the order processing device 114 and/or stored in the storage device 110 as part of the order data 118.

The cap device 222 may be used to cap or otherwise seal a prescription container. In some implementations, the cap device 222 may secure a prescription container with a type of cap in accordance with a user preference (e.g., a preference regarding child resistance, etc.), a plan sponsor preference, a prescriber preference, etc. The cap device 222 may also etch a message into the cap, although this process may be performed by a subsequent device in the high-volume fulfillment center.

The accumulation device 224 accumulates various containers of prescription drugs in a prescription order. The accumulation device 224 may accumulate prescription containers from various devices or areas of the pharmacy. For example, the accumulation device 224 may accumulate prescription containers from the unit of use device 212, the automated dispensing device 214, the manual fulfillment device 216, and the review device 218. The accumulation device 224 may be used to group the prescription containers prior to shipment to the member.

The literature device 228 prints, or otherwise generates, literature to include with each prescription drug order. The literature may be printed on multiple sheets of substrates, such as paper, coated paper, printable polymers, or combinations of the above substrates. The literature printed by the literature device 228 may include information required to accompany the prescription drugs included in a prescription order, other information related to prescription drugs in the order, financial information associated with the order (for example, an invoice or an account statement), etc.

In some implementations, the literature device 228 folds or otherwise prepares the literature for inclusion with a prescription drug order (e.g., in a shipping container). In other implementations, the literature device 228 prints the literature and is separate from another device that prepares the printed literature for inclusion with a prescription order.

The packing device 226 packages the prescription order in preparation for shipping the order. The packing device 226 may box, bag, or otherwise package the fulfilled prescription order for delivery. The packing device 226 may further place inserts (e.g., literature or other papers, etc.) into the packaging received from the literature device 228. For example, bulk prescription orders may be shipped in a box, while other prescription orders may be shipped in a bag, which may be a wrap-seal bag.

The packing device 226 may label the box or bag with an address and a recipient's name. The label may be printed and affixed to the bag or box, be printed directly onto the bag or box, or otherwise associated with the bag or box. The packing device 226 may sort the box or bag for mailing in an efficient manner (e.g., sort by delivery address, etc.). The packing device 226 may include ice or temperature-sensitive elements for prescriptions that are to be kept within a temperature range during shipping (for example, this may be necessary in order to retain efficacy). The ultimate package may then be shipped through postal mail, through a mail order delivery service that ships via ground and/or air (e.g., UPS, FedEx, or DHL, etc.), through a delivery service, through a locker box at a shipping site (e.g., Amazon locker or a PO Box, etc.), or otherwise.

The unit of use packing device 230 packages a unit of use prescription order in preparation for shipping the order. The unit of use packing device 230 may include manual scanning of containers to be bagged for shipping to verify each container in the order. In an example implementation, the manual scanning may be performed at a manual scanning station. The pharmacy fulfillment device 112 may also include a mail manifest device 232 to print mailing labels used by the packing device 226 and may print shipping manifests and packing lists.

While the pharmacy fulfillment device 112 in FIG. 2 is shown to include single devices 206-232, multiple devices may be used. When multiple devices are present, the multiple devices may be of the same device type or models, or may be a different device type or model. The types of devices 206-232 shown in FIG. 2 are example devices. In other configurations of the system 100, lesser, additional, or different types of devices may be included.

Moreover, multiple devices may share processing and/or memory resources. The devices 206-232 may be located in the same area or in different locations. For example, the devices 206-232 may be located in a building or set of adjoining buildings. The devices 206-232 may be interconnected (such as by conveyors), networked, and/or otherwise in contact with one another or integrated with one another (e.g., at the high-volume fulfillment center, etc.). In addition, the functionality of a device may be split among a number of discrete devices and/or combined with other devices.

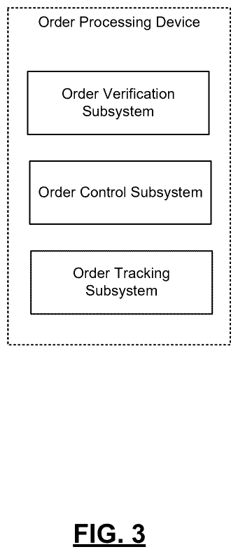

FIG. 3 illustrates the order processing device 114 according to an example implementation. The order processing device 114 may be used by one or more operators to generate prescription orders, make routing decisions, make prescription order consolidation decisions, track literature with the system 100, and/or view order status and other order-related information. For example, the prescription order may be comprised of order components.

The order processing device 114 may receive instructions to fulfill an order without operator intervention. An order component may include a prescription drug fulfilled by use of a container through the system 100. The order processing device 114 may include an order verification subsystem 302, an order control subsystem 304, and/or an order tracking subsystem 306. Other subsystems may also be included in the order processing device 114.

The order verification subsystem 302 may communicate with the benefit manager device 102 to verify the eligibility of the member and review the formulary to determine the appropriate copayment, coinsurance, and deductible for the prescription drug and/or perform a DUR (drug utilization review). Other communications between the order verification subsystem 302 and the benefit manager device 102 may be performed for a variety of purposes.

The order control subsystem 304 controls various movements of the containers and/or pallets along with various filling functions during their progression through the system 100. In some implementations, the order control subsystem 304 may identify the prescribed drug in one or more than one prescription orders as capable of being fulfilled by the automated dispensing device 214. The order control subsystem 304 may determine which prescriptions are to be launched and may determine that a pallet of automated-fill containers is to be launched.

The order control subsystem 304 may determine that an automated-fill prescription of a specific pharmaceutical is to be launched and may examine a queue of orders awaiting fulfillment for other prescription orders, which will be filled with the same pharmaceutical. The order control subsystem 304 may then launch orders with similar automated-fill pharmaceutical needs together in a pallet to the automated dispensing device 214. As the devices 206-232 may be interconnected by a system of conveyors or other container movement systems, the order control subsystem 304 may control various conveyors, for example, to deliver the pallet from the loading device 208 to the manual fulfillment device 216 and from the literature device 228, paperwork as needed to fill the prescription.

The order tracking subsystem 306 may track a prescription order during its progress toward fulfillment. The order tracking subsystem 306 may track, record, and/or update order history, order status, etc. The order tracking subsystem 306 may store data locally (for example, in a memory) or as a portion of the order data 118 stored in the storage device 110.

### Example Monitoring System

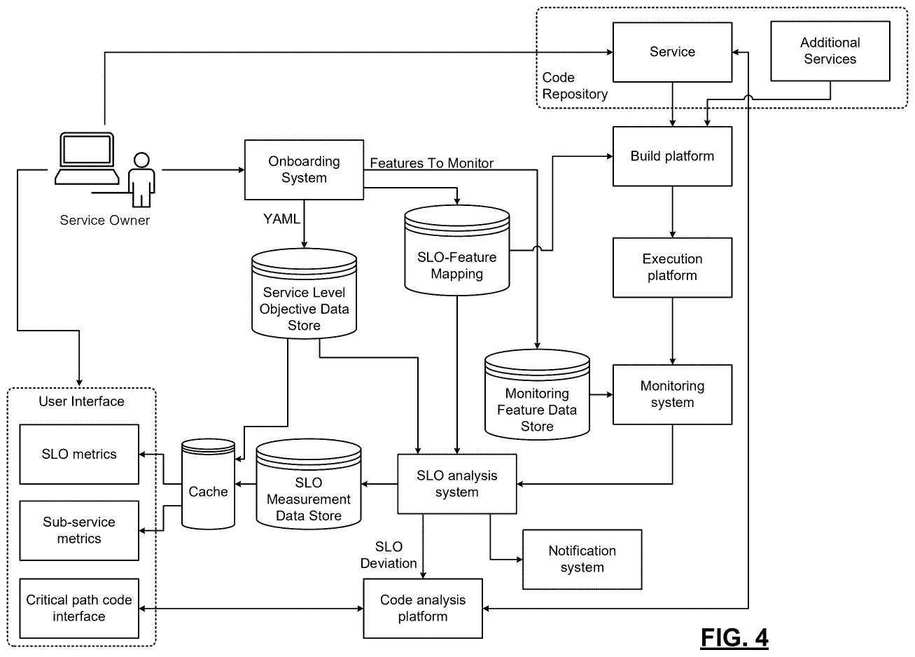

FIG. 4 is a functional block diagram of an example system for enforcing service level objectives. A service owner 404 is responsible for a service 408 defined by code stored in a code repository 442. The code repository 442 may also have code for additional services 446. The service owner 404 uses an onboarding system 420 to set service level objectives (SLOs) for the service 408 and integrate the service 408 with a monitoring system 424. Monitoring system 424 monitors the execution of the service 408 and collects data to measure SLOs of the service 408.

The onboarding system 420 stores data about the SLOs for the service 408 into an SLO data store 428. In various implementations, the SLOs are stored as a Yet Another Markup Language (YAML) file. In various embodiments, the SLO data store 428 is a file store. The onboarding system 420 identifies features of the service 408 that correspond to SLOs and stores information about those features in a monitoring feature data store 432. The monitoring system 424 monitors the specified monitoring features of the service 408 when the service 408 is executed by an execution platform 436, which can include one or more virtual servers, Docker instances, etc. In various implementations, an executable version of the service 408, integrated with the monitoring system 424, is generated by a build platform 438 for execution by the execution platform 436.

The data captured by the monitoring system 424 is provided to an SLO analysis system 440, which determines an SLO based on the captured data. For example, an SLO-feature mapping data store 444 defines how features can be used to determine an SLO. For example, an SLO value for query response time of the service 408 may be calculated by subtracting a time at which a query input processing routine is triggered from a time at which a query result transmission routine completes. The SLO analysis system 440 stores calculated SLO values into an SLO measurement data store 448.

Values of an SLO that fail to meet satisfaction criteria for the SLO may trigger a notification (such as to the service owner 404) by a notification system 452. Satisfaction criteria may be defined by the SLO data store 428. For example, satisfaction criteria may include a range, only an upper threshold, only a lower threshold, etc. As an example, satisfaction criteria may include a test of whether the SLO value is equal to or greater than a lower threshold of 99%. As another example, satisfaction criteria may include a test of whether the SLO value is less than or equal to a time of 400 ms.

There may be different sets of satisfaction criteria. For example, one set of satisfaction criteria may define whether a SLO value strictly meets a SLO, while another set of satisfaction criteria may determine whether the notification system 452 needs to transmit a notification. Another set of satisfaction criteria may determine whether a deviation is sent to a code analysis platform 456.

In various implementations, the code analysis platform 456 analyzes source code of the service 408 in response to an SLO deviation (that is, failure of an SLO value to meet certain satisfaction criteria related to the SLO). Using large language model (LLM) processing, the code analysis platform 456 attempts to identify one or more passages of the source code of the service 408 that are a critical path preventing the SLO from being met. In various implementations, the code analysis platform 456 also determines proposed code changes to shorten the critical path. Information about the source code (such as snippets of source code and/or proposed changes) may be presented to the service owner 404—or a developer who is not the service owner 404—in a critical path code portion 460 of a user interface 464. In various embodiments, an artificial intelligence (AI) agent creates a pull request with the proposed code changes to shorten the critical path. In various embodiments, an AI agent runs continuous integration verification. In various embodiments, an AI agent automatically implements proposed changes, prioritizes changes, and/or generates a risk score of various changes.

The user interface 464 may also include an SLO metrics portion 468 that displays metrics related to SLOs for the service 408. In various implementations, the SLO metrics portion 468 may visually distinguish SLOs that are being violated, such as by using color, font choice, font size, graphics, etc. The SLO metrics portion 468 may also indicate a relative amount of deviation using relative visual approaches, such as by increasing a font size proportionally with respect to the amount an SLO value deviates from the SLO. The SLO metrics portion 468 may offer timeline controls to identify which time and/or date range of the SLO values to show. When multiple SLO values are shown, an aggregate value may be calculated, such as a mathematical average, with other statistical values also available, such as maximum, minimum, standard deviation, etc. In various implementations, a plot of the SLO values over time may be shown—which may be smoothed using a mathematical function such as a rolling average—to help identify SLO deviations that show up at certain times or dates.

The user interface 464 may also show metrics related to components of the service 408 in a sub-service metrics portion 472. For example, an SLO for the service 408 may be related to query processing, and multiple sub-services may be responsible for generating a response to the query. The sub-service metrics portion 472 may present information on the sub-services to help identify where processing time is being spent, where failures are occurring, etc.

The values presented by the SLO metrics portion 468 and the sub-service metrics portion 472 may be obtained from a cache 476 rather than directly from the SLO measurement data store 448.

### Example Analysis Process

In various embodiments, the monitoring system includes one or more monitoring tools that interface with feature code to ensure that the feature meets a corresponding SLO. For example, the monitoring system analyzes the execution of a feature corresponding to a response time SLO to ensure it meets the satisfaction criteria associated with the SLO. In various embodiments, response time (or other SLOs) can be measured in various ways. In various embodiments, the monitoring tools look for “start” and “end” markers in the feature code (such as determining when a first user-selected (or SLO-specified) code segment is executed and when a second code segment is executed). In various embodiments, the feature code includes one or more monitoring hooks that trigger the start and end of monitoring by the monitoring tools when the hooks are called. In various embodiments, the monitoring tools modify the feature code to include monitoring hooks and/or code markers to indicate when points of interest occur in the code.

### Example Monitoring Process

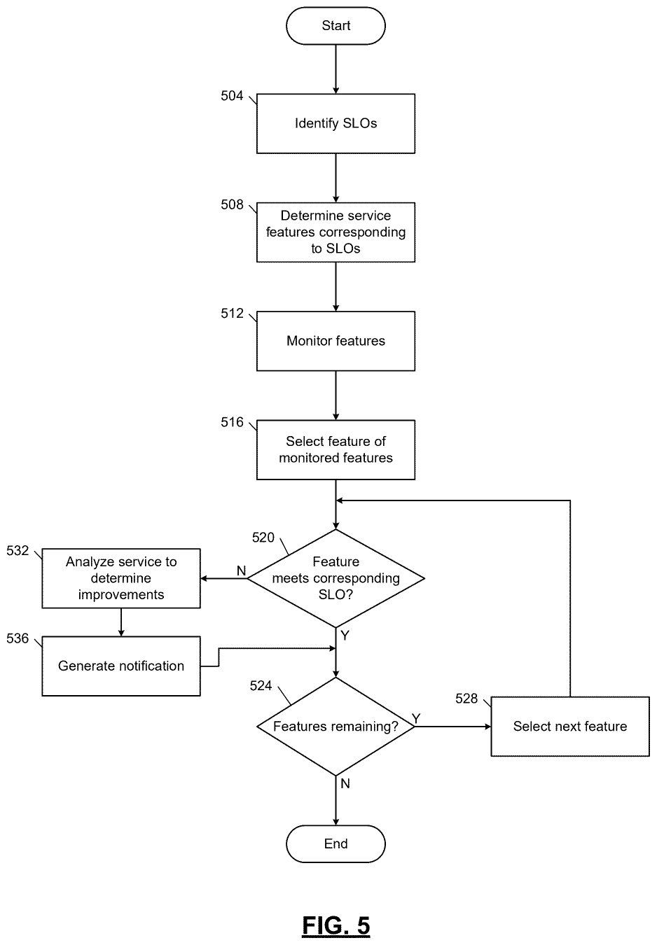

FIG. 5 is a flowchart of an example method for enforcing service level objectives. Control begins at 504 (for example, after a service has been added to the monitoring system) and identifies SLOs associated with the system. At 508, control determines which features of the service correspond to the identified SLOs. At 512, control monitors the features. At 516, control selects a first feature of the monitored features. In various embodiments, control selects the first feature after a set period of monitoring has elapsed or after the feature has been triggered. At 520, control determines whether the selected feature meets its corresponding SLO satisfaction criteria. If the SLO satisfaction criteria have been met, control transfers to 524. If the SLO satisfaction criteria have not been met, control transfers to 532.

At 532, control analyzes the service feature to determine a code improvement to the service (for example, by shortening the critical path). After 532, control continues to 536 and control generates a notification that the service did not meet the SLO. In various embodiments, the notification includes the determined code improvement. Control then transfers to 524. At 524, control determines whether there are features remaining that require analysis. If additional features remain, control transfers to 528 and selects the next feature. Control then returns to 520.

### Example Monitoring System Subsystems

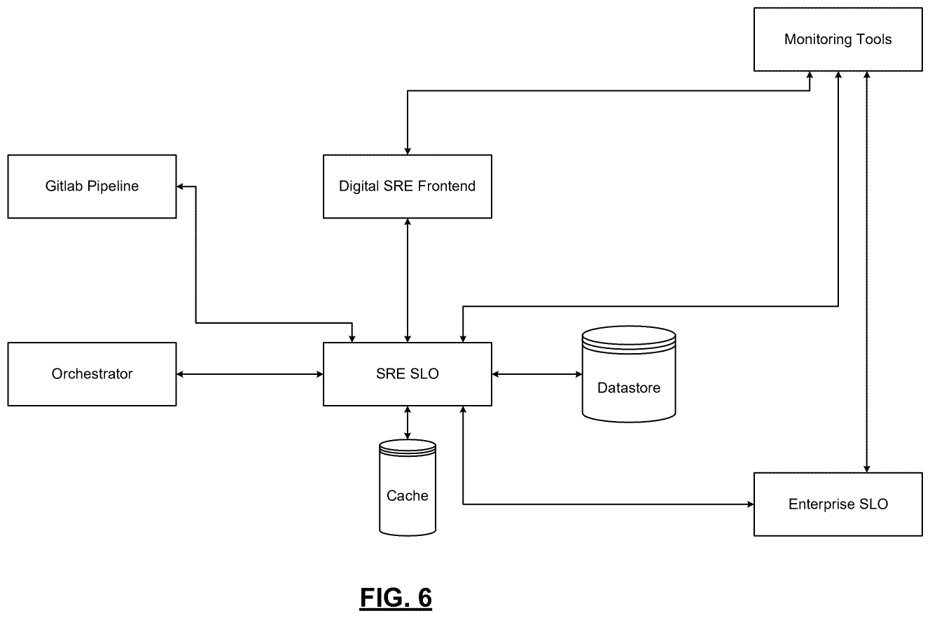

FIG. 6 is a functional block diagram of an example system for enforcing service level objectives. In various embodiments, the monitoring system includes several sub-systems including monitoring tools (such as Dynatrace, New Relic, and/or Splunk), an orchestrator (such as Jenkins), a pipeline, a machine learning model, a user interface, a cache, and/or a datastore.

### Database Schema

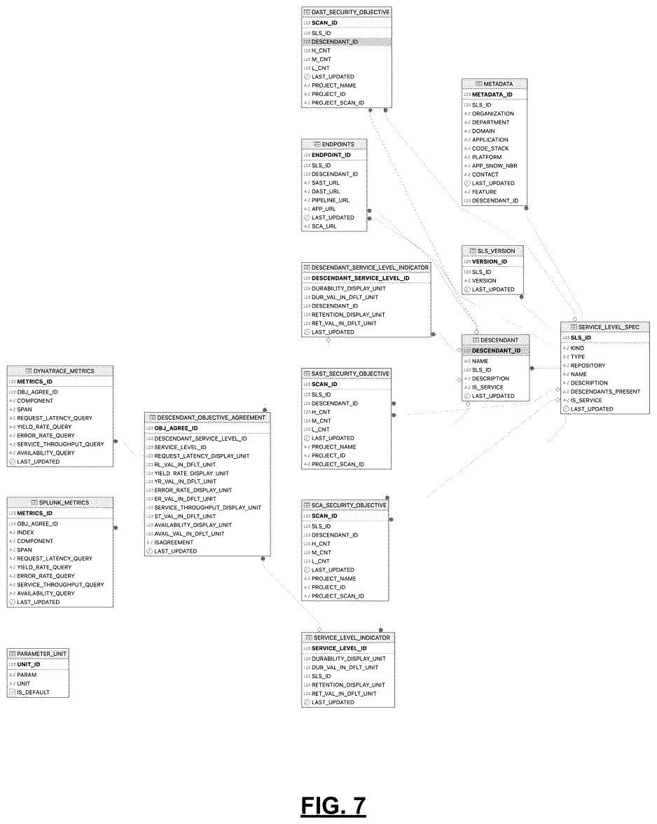

FIG. 7 is an example database schema for SLOs and services. In various embodiments, services and features are stored in a database with measured metrics for each corresponding SLO.

### Example User Interfaces

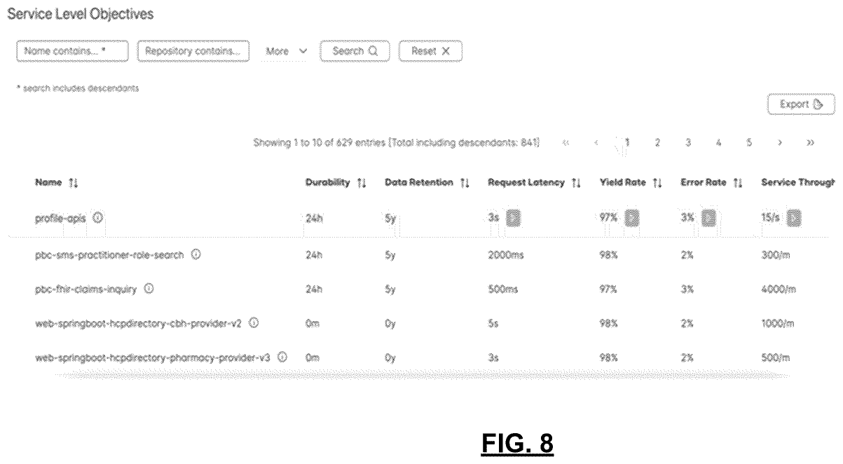

FIG. 8 is an example user interface for monitoring service level objectives. In various embodiments, each service can be viewed with its corresponding SLO compliance.

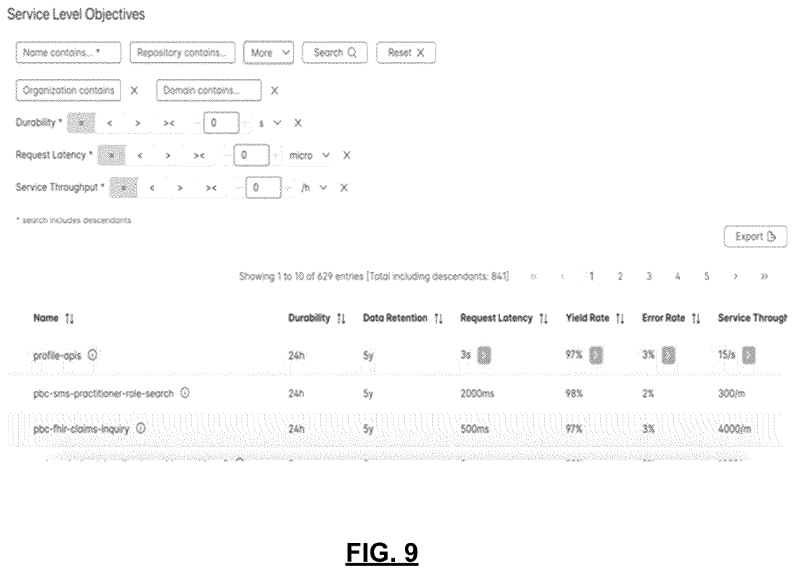

FIG. 9 is an example user interface for managing service level objectives. SLOs can be added for each service feature.

### Example Deployment

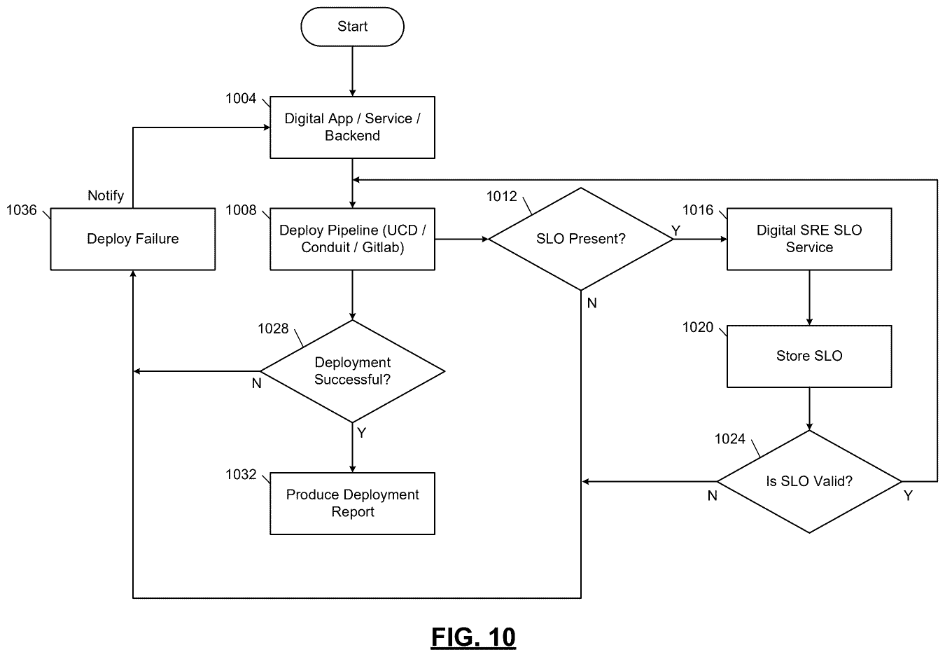

FIG. 10 is a flowchart and block diagram of an example method for deploying service level objective monitoring. The monitoring system backend (1004) deploys the pipeline (1008) and confirms whether an SLO is present (1012). If the SLO is present, the digital SRE SLO service (1016) stores (1020) the SLO and determines (1024) whether the SLO is valid. If the SLO is valid, the pipeline determines (1028) whether the deployment was successful and produces a deployment report (1032). If the SLO was not present, or was not valid, the deployment has failed and a notification (1036) is sent to the backend.

### Example SLOs

Example 1: Request Latency. Request latency generally indicates how long a service takes to return a response to a request. An example ideal latency may be 1-50 ms, however, this is not feasible for all the services. Therefore, an acceptable latency ranges from a few milliseconds to a few hundred milliseconds. Depending on how stressed a service is, an upper bound of 1-2 seconds may be acceptable (for example, in scenarios where a service receives millions of requests).

Example 2: Yield. Yield indicates the rate at which requests succeed. Generally, not all requests received by a service will be successful, and some requests may result in an error for various reasons. Yield can be affected by the throughput a service can handle, the number of invalid requests received, and/or bursts in the amount of information payload received.

Example 3: Error Rate. Error rate indicates the rate at which requests result in errors (yield %+error rate % should be 100% in total). The error rate should be a small fraction of all requests received.

Example 4: Service Throughput. Service throughput is an indication of how many requests a service or application can process (for example, requests per second).

Example 5: Availability. Availability is a percentage of a period or interval in which a service is usable. 100% availability of a service or application indicates that at any point in time, the service or application is available and usable. Although 100% availability is generally impossible, near-100% availability is often readily achievable. Generally, in organizations where a service plays a crucial role, even 1% downtime is unacceptable. In various embodiments, availability can be increased with multiple production environments.

Example 6: Durability. Durability is the likelihood that data (such as grid, scale, or cache objects) will be retained over a long period of time. Durability factors include whether a user accesses on-demand data, whether the user obtains the cached data on subsequent calls, and the durability of the data retained in cache. Services frequently use this feature to perform more efficiently and provide better performance.

Example 7: Data Retention: Data retention is the period of time that data is retained before being purged. In contrast to duration, which describes how long data is cached, data retention describes how long data is stored.

The below is an example of a set of SLOs for an application.
kind: service-level-objective
type: api
name: <your-application>
repository: <your git repository url>
description: <your application description>
is.service: Y
metadata:
   organization: cigna
   department: digital
   domain: <your domain>
   application: <your application>
   code.stack: <your code stack>
   platform: <your platform>
   ASNumber: <your AS number—could be a single value or multiple values with a comma-separation>
   contact: <your e-mail address—could be a single value or multiple values with comma separation>
service:
   level:
      indicators:
         durability: 2 h
         data.retention: 5 y
         objective:
         request.latency: 1 s
         yield.rate: 98%
         error.rate: 2%
         service.throughput: 5000/m
         availability: 99.5%
         agreement:
         request.latency: 2 s
         yield.rate: 97%
         error.rate: 3%
         service.throughput: 4000/m
         availability: 98%
metrics:
   splunk:
      index: <your-index>
      component: <your splunk component>
      span: 1 d
   dynatrace:
      component: <your dynatrace component>
      span: 1 d

### Security Vulnerability Detection

In various embodiments, the system of the present disclosure also detects and corrects vulnerabilities in the various resources and/or services that are monitored by the system. Using a tailored prompt, an AI agent is instructed to identify vulnerabilities and generate a pull request to integrate a patch for the vulnerabilities into the monitored resource.

In various embodiments, the agent is instructed to create a new git branch for the vulnerability patch. The agent creates a new release branch from the base branch and, upon completion, creates a pull request containing the implemented security fixes.

In various embodiments, a rigid JSON output is enforced. The agent sends a structured JSON output in a separate message containing no other text, which is designated as the primary deliverable and is produced in various scenarios, including full success, complete failure, and partial completion. In various embodiments, the delivery sequence comprises: (a) completing the remediation work; (b) creating and uploading a session remediation prompt artifact; (c) sending the JSON message; (d) awaiting confirmation; and (e) sending a separate completion message.

Using a tailored prompt improves accuracy, reduces computational time, and improves computational efficiency by reducing the amount of computation required to determine how to execute the prompt instructions. In various embodiments, the tailored prompt includes several steps, such as those described below.

### Repository Access and Cloning

First, the agent is instructed to clone a code repository corresponding to the monitored service via HTTPS or SSH. If cloning fails (including failures such as server 403 errors, authentication failures, or network issues), the agent is instructed to deliver JSON output with the repository access status set to “FAILED” and the specific error is documented.

### Vulnerability Ingestion

Next, the agent is instructed to ingest vulnerability data from an attachment link when specific vulnerabilities are not directly specified in the prompt. The ingestion procedure includes verifying accessibility of the attachment, detecting the file format (such as CSV, JSON, XML, plain text, Excel, and/or RTF), inspecting content, detecting the multipurpose internet mail extension (MIME) type, parsing the content using format-appropriate logic, and normalizing the extracted data to standard vulnerability fields. In various embodiments, the agent is instructed to address only the vulnerabilities listed in the prompt or attachment and does not scan for additional vulnerabilities.

### Software Composition Analysis (SCA) Vulnerability Remediation

In various embodiments, the prompt instructs the agent to identify and update vulnerable software dependencies across dependency manifest file types to secure versions. The agent is instructed that the fixed vulnerability count must equal the total number of individual vulnerability entries successfully remediated.

In various embodiments, the agent is instructed to identify vulnerable dependencies across various build files and update them to secure versions using appropriate package managers. In various embodiments, the agent is instructed to update runtime platforms used by the monitored service, such as Java, Spring Boot, Node.js, or Python, to the latest stable version. For major version upgrades, a deployment compatibility verification procedure is performed, which comprises framework migration checks, database compatibility checks, security configuration updates, container and deployment compatibility checks, and integration and connectivity verification, all of which must be confirmed complete before pull request creation.

### Static Application Security Testing (SAST) Vulnerability Remediation

In various embodiments, the prompt includes instructions for SAST vulnerability remediation, which includes identifying and fixing security vulnerabilities (such as hardcoded secrets, SQL injection, cross-site scripting, command injection, and server-side request forgery) in source code. In various embodiments, the SAST vulnerability remediation instructions include integrity requirements in which all submitted files must be complete, and files too large to process are skipped and documented.

In various embodiments, the prompt includes instructions for a build verification step using project-appropriate compilation commands. In various embodiments, the prompt instructs the agent to fix build errors before proceeding to pull request creation. In various embodiments, the prompt also instructs the agent to produce various deliverables, such as a vulnerability report document and a fixed source files archive. In various embodiments, the delivery sequence includes a structured reasoning block to validate JSON output before transmission. In various embodiments, the prompt instructs the AI agent to open pull requests, prioritize changes, and generate a risk analysis.

### Conclusion

The above description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. In the written description and claims, one or more steps within a method may be executed in a different order (or concurrently) without altering the principles of the present disclosure. Similarly, one or more instructions stored in a non-transitory computer-readable medium may be executed in a different order (or concurrently) without altering the principles of the present disclosure. Unless indicated otherwise, numbering or other labeling of instructions or method steps is done for convenient reference, not to indicate a fixed order.

Numerical terms, such as “first,” “second,” and “third,” may be used in the disclosure and claims as unique labels: they are not used to imply a sequence or order unless the context clearly indicates otherwise. In other words, a “second” element could be relabeled as a “first” element without departing from the principles of the present disclosure. Further, the presence of a “second” element does not imply or require the presence of a “first” element. Similarly, the presence of a “first” element does not imply or require the presence of a “second” element.

Unless the context clearly indicates otherwise, the singular articles “a,” “an,” and “the” before a noun do not restrict the noun to a single instance. The verbs “comprise,” “include,” and “have” are inclusive and therefore specify the presence of elements without excluding the presence of one or more additional elements.

Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “coupled,” and “engaged.” Unless explicitly described as being “direct,” when a relationship between first and second elements is described in the above disclosure, that relationship encompasses a direct relationship where no other intervening elements are present between the first and second elements as well as an indirect relationship where one or more intervening elements are present between the first and second elements.

The term “set” generally means a grouping of one or more elements. The elements of a set do not necessarily need to have any characteristics in common or otherwise belong together. However, in various implementations, a “set” may, in certain circumstances, be the empty set (in other words, the set has zero elements in those circumstances). As an example, a set of search results resulting from a query may, depending on the query, be the empty set. In contexts where it is not otherwise clear, the term “non-empty set” can be used to explicitly denote exclusion of the empty set—that is, a non-empty set will always have one or more elements.

A “subset” of a first set generally includes some of the elements of the first set. In various implementations, a subset of the first set is not necessarily a proper subset: in certain circumstances, the subset may be coextensive with (equal to) the first set (in other words, the subset may include the same elements as the first set). In contexts where it is not otherwise clear, the term “proper subset” can be used to explicitly denote that a subset of the first set must exclude at least one of the elements of the first set. Further, in various implementations, the term “subset” does not necessarily exclude the empty set. As an example, consider a set of candidates that was selected based on first criteria and a subset of the set of candidates that was selected based on second criteria; if no elements of the set of candidates met the second criteria, the subset may be the empty set. In contexts where it is not otherwise clear, the term “non-empty subset” can be used to explicitly denote exclusion of the empty set.

The phrase “at least one of A, B, and C” should be construed to mean a logical (A OR B OR C), using a non-exclusive logical OR, and should not be construed to mean “at least one of A, at least one of B, and at least one of C.” The phrase “at least one of A, B, or C” should be construed to mean a logical (A OR B OR C), using a non-exclusive logical OR. The phrase “A, B, and/or C” should be construed in the same way as the phrase “at least one of A, B, and C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgments of, the information to element A.

In this application, including the definitions below, the term “module” can be replaced with the term “controller” or the term “circuit.” In this application, the term “controller” can be replaced with the term “module.” The term “module” may refer to, be part of, or include processor hardware (shared, dedicated, or group) that executes code coupled with memory hardware (shared, dedicated, or group) that stores code executed by the processor hardware.

The module may include or be connected to one or more interface circuits configured to couple the module to one or more networks. An interface circuit may include, for example, one or more of ports, transceivers, antennas, physical-layer (PHY) circuitry, and medium access control (MAC) circuitry. Examples of networks include a wireless personal area network (WPAN), a local area network (LAN), a wireless local area network (WLAN), and a wide area network (WAN), including private networks, public networks, the Internet, and other Internet Protocol (IP)-based networks. Examples of WLAN technologies include IEEE 802.11 (sometimes referred to as Wi-Fi) wireless local area networking technology. Examples of wired LAN technologies include IEEE 802.3 (sometimes referred to as Ethernet) networking technology. Examples of WPAN technologies include IEEE 802.15.4-based protocols, such as Zigbee-or Thread-based communications, and Bluetooth-based protocols, including Bluetooth Classic and Bluetooth Low Energy (BLE), as specified by the Bluetooth SIG. Examples of wireless wide area network (WWAN) technologies include cellular technologies, such as Long-Term Evolution (LTE) and 5G New Radio (5G NR).

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a WAN such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module. For example, the client module may include a native or web application executing on a client device and in network communication with the server module.

The term “code,” as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

The memory hardware may also store data together with or separate from the code. Shared memory hardware encompasses a single memory device that stores some or all code from multiple modules. One example of shared memory hardware may be level 1 cache on or near a microprocessor die, which may store code from multiple modules. Another example of shared memory hardware may be persistent storage, such as a solid-state drive (SSD) or magnetic hard disk drive (HDD), which may store code from multiple modules. Group memory hardware encompasses a memory device that, in combination with other memory devices, stores some or all code from one or more modules. One example of group memory hardware is a storage area network (SAN), which may store code of a particular module across multiple physical devices. Another example of group memory hardware is random access memory of each of a set of servers that, in combination, store code of a particular module. The term “memory hardware” is a subset of the term “computer-readable medium.”

The apparatuses and methods described in this application may be partially or fully implemented by a special-purpose computer created by configuring a general-purpose computer to execute one or more particular functions embodied in computer programs. Such apparatuses and methods may be described as computerized or computer-implemented apparatuses and methods. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special-purpose computer, device drivers that interact with particular devices of the special-purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

The term non-transitory computer-readable medium does not encompass transitory electrical or electromagnetic signals propagating through a medium (such as on a carrier wave). Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD or DVD).

1. A method comprising:
receiving a data structure describing a set of services and a set of criteria for the set of services, wherein:
the data structure includes a set of key-value pairs,
a first key-value pair of the set of key-value pairs contains a key corresponding to a specified service of the set of services, and
the first key-value pair contains a value including:
a criterion of the set of criteria, and
a query corresponding to the set of criteria and to the specified service;
storing the set of services and the set of criteria;
monitoring the set of services;
based on the monitoring, determining whether the set of services meets the set of criteria;
in response to a determination that the set of services does not meet the set of criteria:
determining, using a machine learning model, a set of improvements for the set of services, and
generating a notification including the set of improvements; and
in response to a determination that the set of services meets the set of criteria, forgoing determining the set of improvements and forgoing generating the notification.

2. The method of claim 1 wherein the query of the first key-value pair corresponds to a command for testing the specified service.

3. The method of claim 1 further comprising generating the data structure based on a code repository.

4. The method of claim 1 wherein the set of criteria includes at least one of:
a criterion that is met when a request latency is below a latency threshold,
a criterion that is met when a yield level is above a yield threshold,
a criterion that is met when an error rate is below an error threshold,
a criterion that is met when a service throughput level is above a throughput threshold,
a criterion that is met when an availability level is above an availability threshold,
a criterion that is met when a data durability level is above a durability threshold, or
a criterion that is met when a data retention level is above a retention threshold.

5. The method of claim 1 wherein determining the set of improvements includes analyzing, via a machine learning model, source code associated with the set of services.

6. The method of claim 1 further comprising directing an artificial intelligence agent with a prompt, wherein the prompt includes instructions for:
cloning a software repository;
determining whether a specified vulnerability exists in the software repository; and
in response to a determination that the specified vulnerability exists in the software repository:
determining a remediation for the specified vulnerability, and
creating a request to apply the remediation to the software repository.

7. The method of claim 6 wherein the remediation includes updating a runtime platform used by the software repository.

8. The method of claim 6, wherein the prompt includes instructions for outputting a structured data file describing outcomes of the remediation.

9. The method of claim 6, wherein the prompt includes instructions for determining a quantity of remediated vulnerabilities.

10. The method of claim 6, wherein the prompt includes instructions to ignore vulnerabilities that are not specified by the prompt.

11. The method of claim 6, wherein:
the prompt includes instructions for, in response to a determination that cloning the software repository has failed, outputting a structured data file, and
the structured data file includes a failure status flag and information indicating an error associated with the failure status flag.

12. A system comprising:
memory hardware configured to store instructions; and
processor hardware configured to execute the instructions stored by the memory hardware, wherein the instructions include:
receiving a data structure describing a set of services and a set of criteria for the set of services, wherein:
the data structure includes a set of key-value pairs,
a first key-value pair of the set of key-value pairs contains a key corresponding to a specified service of the set of services, and
the first key-value pair contains a value including:
a criterion of the set of criteria, and
a query corresponding to the set of criteria and to the specified service;
storing the set of services and the set of criteria;
monitoring the set of services;
based on the monitoring, determining whether the set of services meets the set of criteria;
in response to a determination that the set of services does not meet the set of criteria:
determining, using a machine learning model, a set of improvements for the set of services, and
generating a notification including the set of improvements; and
in response to a determination that the set of services meets the set of criteria, forgoing determining the set of improvements and forgoing generating the notification.

13. The system of claim 12 wherein the query of the first key-value pair corresponds to a command for testing the specified service.

14. The system of claim 12 wherein the instructions include generating the data structure based on a code repository.

15. The system of claim 12 wherein the set of criteria includes at least one of:
a criterion that is met when a request latency is below a latency threshold,
a criterion that is met when a yield level is above a yield threshold,
a criterion that is met when an error rate is below an error threshold,
a criterion that is met when a service throughput level is above a throughput threshold,
a criterion that is met when an availability level is above an availability threshold,
a criterion that is met when a data durability level is above a durability threshold, or
a criterion that is met when a data retention level is above a retention threshold.

16. A non-transitory computer-readable medium comprising processor-executable instructions, the instructions including:
receiving a data structure describing a set of services and a set of criteria for the set of services, wherein:
the data structure includes a set of key-value pairs,
a first key-value pair of the set of key-value pairs contains a key corresponding to a specified service of the set of services, and
the first key-value pair contains a value including:
a criterion of the set of criteria, and
a query corresponding to the set of criteria and to the specified service;
storing the set of services and the set of criteria;
monitoring the set of services;
based on the monitoring, determining whether the set of services meets the set of criteria;
in response to a determination that the set of services does not meet the set of criteria:
determining, using a machine learning model, a set of improvements for the set of services, and
generating a notification including the set of improvements; and
in response to a determination that the set of services meets the set of criteria, forgoing determining the set of improvements and forgoing generating the notification.

17. The non-transitory computer-readable medium of claim 16 wherein the query of the first key-value pair corresponds to a command for testing the specified service.

18. The non-transitory computer-readable medium of claim 16 wherein the instructions include generating the data structure based on a code repository.

19. The non-transitory computer-readable medium of claim 16 wherein the set of criteria includes at least one of:
a criterion that is met when a request latency is below a latency threshold,
a criterion that is met when a yield level is above a yield threshold,
a criterion that is met when an error rate is below an error threshold,
a criterion that is met when a service throughput level is above a throughput threshold,
a criterion that is met when an availability level is above an availability threshold,
a criterion that is met when a data durability level is above a durability threshold, or
a criterion that is met when a data retention level is above a retention threshold.

20. The non-transitory computer-readable medium of claim 16 wherein determining the set of improvements includes analyzing, via a machine learning model, source code associated with the set of services.
